(19) United States
(12) Patent Application Publication
(10) Pub. No.: US 2022/0034085 A1
(43) Pub. Date: Feb. 3, 2022

(54) ACOUSTIC ADJUSTMENT SHELF

(71) Applicant: Nihon Onkyo Engineering Co., Ltd., Tokyo (JP)

(72) Inventors: Megumi Kono, Tokyo (JP); Yasuhiro Sakiyama, Tokyo (JP); Kazuhiro Makino, Tokyo (JP); Kenta Negi, Tokyo (JP); Masayuki Hirata, Tokyo (JP); Shinji Ohashi, Tokyo (JP); Hiroshi Ohyama, Tokyo (JP); Koichi Yamashita, Tokyo (JP)

(73) Assignee: Nihon Onkyo Engineering Co., Ltd., Tokyo (JP)

(21) Appl. No.: 17/421,970

(22) PCT Filed: Mar. 14, 2019
(86) PCT No.: PCT/JP2019/010485

§ 371 Date: Jul. 9, 2021

(51) Int. Cl. E04B 1/99; G10K 11/16

(52) U.S. Cl. CPC E04B 1/99; G10K 11/16

(57) ABSTRACT

An acoustic arrangement shelf is configured to be capable of facilitating adjustment of acoustic properties and be capable of enhancing aesthetic appeal of a space for which the acoustic properties are to be adjusted. The acoustic arrangement shelf includes: a shelf frame including a plurality of segments; and an acoustic adjustment member configured to be removably placed in at least one of the segments and change a property of input sound.

### TECHNICAL FIELD

The present invention relates to an acoustic arrangement shelf configured to adjust acoustic properties.

### BACKGROUND ART

In various acoustic rooms, such as studios, listening rooms, halls, or the like, an acoustic adjustment member may be placed along a wall surface of the acoustic room, for example, its side wall surface, its ceiling surface, or the like, to adjust the acoustic properties of the acoustic room. As the acoustic adjustment member, a sound absorber, an acoustic reflector, an acoustic diffuser, and the like are presented. The sound absorber has a sound absorbing property that enables absorption of input sound. The sound absorber includes a sound absorbing cushion made from porous material, such as glass wool, rock wool, or the like. The acoustic reflector has acoustic reflecting properties that each reflect input sound. The acoustic reflector includes an acoustic reflecting plate. The acoustic diffuser has columnar portions configured to reflect input sound so as to gain an acoustic diffusing property that diffuses the sound. The acoustic diffuser also has acoustic reflecting properties.

The acoustic adjustment member, as described above, is singly placed so as to be exposed within an acoustic room while covering the wall surface. Alternatively, the acoustic adjustment member may be singly mounted to the wall surface so as to be exposed within an acoustic room (see, for example, Patent Document 1).

### CITATION LIST

### Patent Document

[Patent Document 1] WO 2009/142267 A1

### SUMMARY OF INVENTION

### Technical Problem

Installing operations including: a task to singly place the acoustic adjustment member, such as the sound absorber, the acoustic reflector, the acoustic diffuser, or the like to be exposed within the acoustic room while covering the wall surface; a task to singly mount the acoustic adjustment member to the wall surface to be exposed within the acoustic room; and the like, are extensive. Accordingly, it is troublesome to redo mounting the previously mounted acoustic adjustment members to change the acoustic properties, such as sound absorbing properties, acoustic reflecting properties, acoustic diffusing properties, and/or the like.

Additionally, the acoustic adjustment member, such as the sound absorber, the acoustic reflector, the acoustic diffuser, and/or the like, is sterile, and thus, is not aesthetically pleasing. As a result, the interior of an acoustic room to which the acoustic adjustment member is placed singly, is less aesthetically appealing. In particular, this is a problem in view of a trend toward an increasing number of desires to improve the acoustic properties of a room even in ordinary home or the like by placing the acoustic adjustment member.

In view of the circumstances described above, the present invention provides an acoustic arrangement shelf that can facilitate adjustment of acoustic properties, and can enhance the aesthetic appeal of a space for which the acoustic properties are to be adjusted.

### Solution to Problem

To solve the problems described above, an acoustic arrangement shelf according to an aspect includes: a shelf frame including a plurality of segments; and an acoustic adjustment member configured to be removably placed in at least one of the segments and change a property of input sound.

### Advantageous Effects of Invention

An acoustic arrangement shelf according to the aspect, can facilitate adjustment of acoustic properties, and can enhance aesthetic appeal of a space for which the acoustic properties are to be adjusted.

### BRIEF DESCRIPTION OF DRAWINGS

FIG. 1 is a perspective view schematically showing an acoustic arrangement shelf according to a First Aspect of the present Embodiment.

FIG. 2 is a front view schematically showing the acoustic arrangement shelf according to the First Aspect of the present Embodiment.

FIG. 3 is a sectional view taken along line A-A of FIG. 2.

FIG. 4 is a sectional view taken along line B-B of FIG. 2.

FIG. 5 is a front view schematically showing the acoustic arrangement shelf according to a Second Aspect of the present Embodiment.

FIG. 6 is a front view schematically showing the acoustic arrangement shelf according to a Third Aspect of the present Embodiment.

FIG. 7 is a front view schematically showing the acoustic arrangement shelf according to a Fourth Aspect of the present Embodiment.

FIG. 8 is a front view schematically showing the acoustic arrangement shelf according to a Fifth Aspect of the present Embodiment.

FIG. 9 is a front view schematically showing the acoustic arrangement shelf according to a Sixth Aspect of the present Embodiment.

FIG. 10 is a graph indicating relationships between acoustic frequency and sound absorption coefficient in acoustic arrangement shelves of Examples 1 to 5.

### DESCRIPTION OF EMBODIMENTS

An acoustic arrangement shelf according to the present Embodiment will be described below. The acoustic arrangement shelf is configured to be placed in a space for which acoustic properties are to be adjusted (hereinafter referred to as an “acoustic adjustment space”), and is configured to adjust the acoustic properties of the acoustic adjustment space. The acoustic adjustment space may be a space defined by a floor surface, a wall surface, and the like of a room or the like. The acoustic adjustment space may be a space that a person can enter. The acoustic adjustment space may be a space substantially closed and separated from the outside. Alternatively, the acoustic adjustment space may be a space partially open to the outside and partially closed and separated from the outside. For example, a room including an acoustic adjustment space (hereinafter referred to as an “acoustic adjustment room”), may be: an acoustic room, such as a studio, a listening room, a hall, and the like; a conference room; an office room; an entrance hall; a waiting room; a room of an ordinary home; or the like. However, the acoustic adjustment room may, of course, be other than the examples provided above. Furthermore, the acoustic adjustment space can be a space having conditions other than those described above.

### “Basic Configuration of Acoustic Arrangement Shelf”

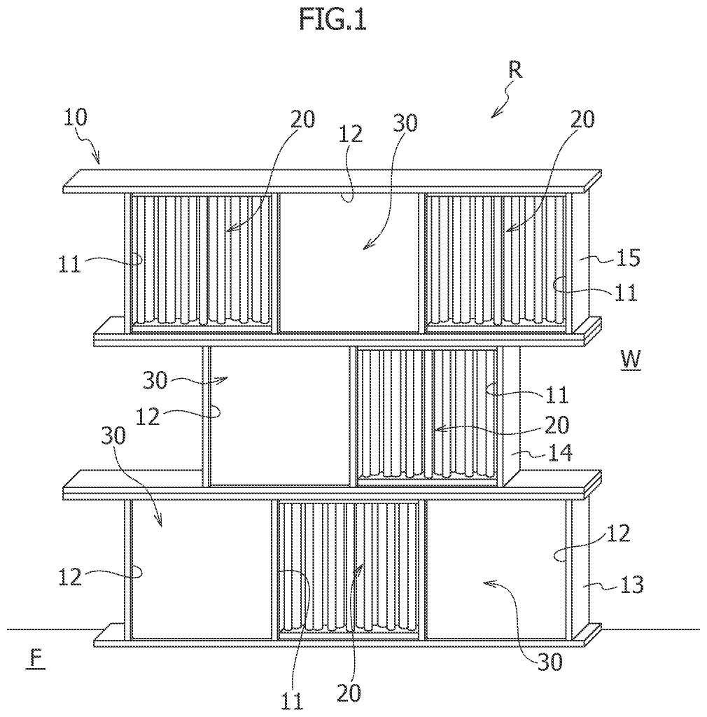

With reference to FIGS. 1 to 9, the acoustic arrangement shelf according to the present Embodiment has a basic configuration as described below. As shown in FIGS. 1 to 9, the acoustic arrangement shelf includes a shelf frame 10 that includes segments 11 and/or 12.

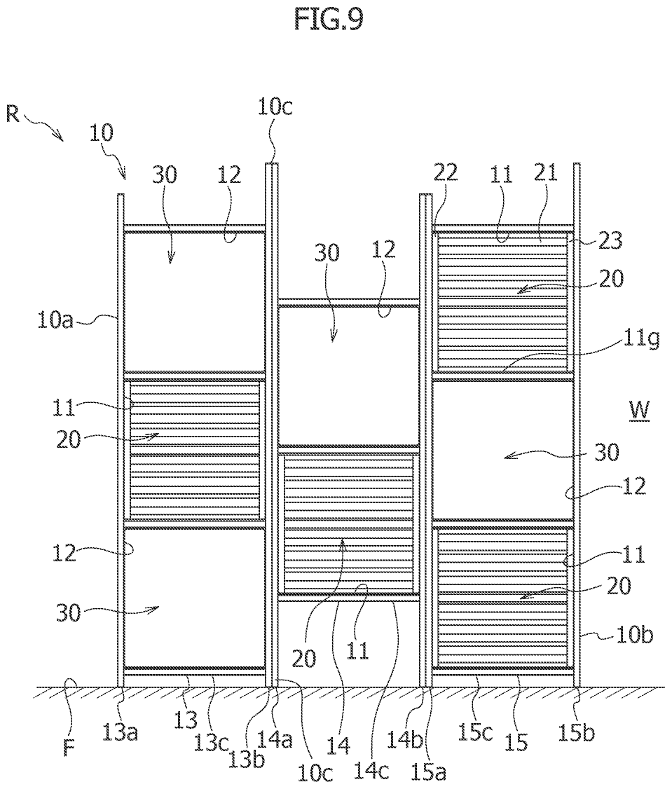

A position in which the shelf frame 10 is placed as shown in FIGS. 1 to 8, is defined as a basic position. A position in which the shelf frame 10 is placed as shown in FIG. 9 to be displaced sideways from the basic position, is defined as a sideways position.

As used herein, the shelf frame 1 has a depth direction, a width direction, and a height direction that are defined with reference to the basic position. Thus, even when the shelf frame 10 is placed in a position other than the basic position, for example, in the sideways position, the depth, width, and height directions defined with reference to the basic position are used. For example, the actual depth direction, the width direction, and the height direction of the shelf frame 10 when placed in the sideways position as shown in FIG. 9, are called the depth direction, the height direction, and the width direction, respectively, with reference to the basic position. The depth direction, the width direction, and the height direction of the acoustic arrangement shelf, are identical with the depth direction, the width direction, and the height direction of the shelf frame 10, respectively.

As shown in FIGS. 1 to 8, in the basic position, a bottom portion 10a of the shelf frame 10 in the height direction faces a floor surface F of the acoustic adjustment room R. A top portion 10b of the shelf frame 10 in the height direction faces a ceiling surface (not shown) of the acoustic adjustment room R. The shelf frame 10 in the basic position is placed while the bottom portion 10a thereof is in contact with the floor surface F of the acoustic adjustment room R. That is, the shelf frame 10 in the basic position is placed on the floor surface F of the acoustic adjustment room R. Furthermore, the shelf frame 10 in the basic position can be placed along a side wall surface W. This, however, is not a limitation of the present invention. The shelf frame can also be placed while the bottom portion thereof is spaced apart from the floor surface of the acoustic adjustment room in the height direction and a back surface of the shelf frame is mounted to the side wall surface of the acoustic adjustment room.

As shown in FIGS. 1 to 9, the acoustic arrangement shelf includes acoustic adjustment member(s) 20 and/or 30 configured to change properties of input sound. The acoustic adjustment member 20 and/or 30 is removably placed in at least one of the segments 11 and/or 12.

As shown in FIGS. 1 to 7 and 9, the acoustic adjustment member 20 can be an acoustic diffuser 20 that includes a plurality of columnar portions 21 each configured to reflect input sound. As shown in FIGS. 1 to 6 and 8 to 9, the acoustic adjustment member 30 can also be a sound absorbing cushion 30 configured to absorb sound. Hereinafter, the segment 11 in which the acoustic diffuser 20 is placed, is called a diffusion segment 11, and the segment 12 in which the sound absorbing cushion 30 is placed, is called a sound absorption segment 12. This, however, is not a limitation of the acoustic adjustment members. For example, the acoustic adjustment member can be: a sound absorber other than a sound absorbing cushion; an acoustic reflector, such as an acoustic reflecting plate or the like; or the like.

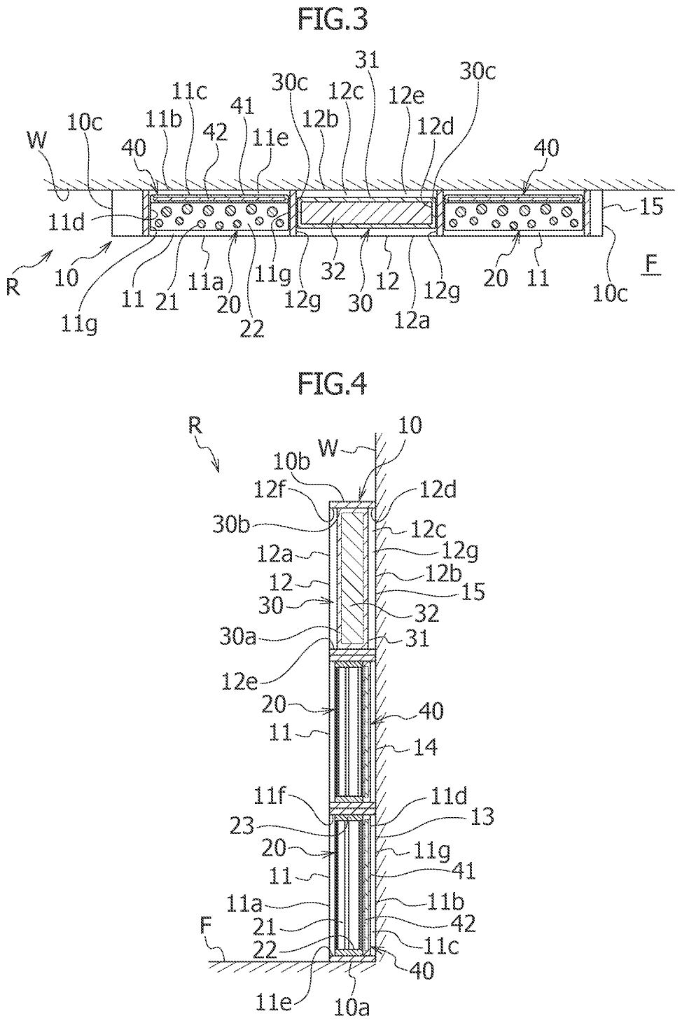

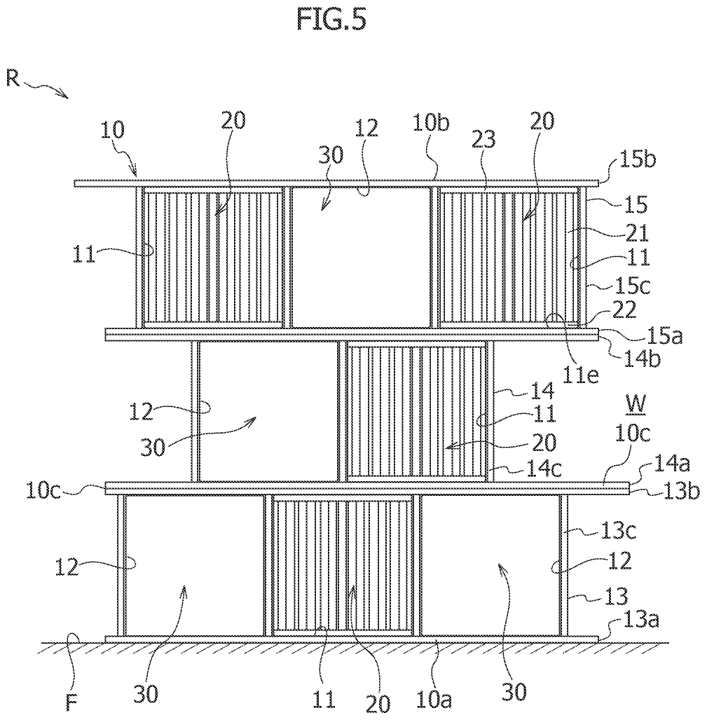

As shown in FIGS. 3 and 4, the acoustic arrangement shelf can include an additional acoustic adjustment member 40 configured to change a property of input sound. The additional acoustic adjustment member 40 is removably placed in the diffusion segment 11 on the back side of the shelf frame 1 with respect to the acoustic diffuser 20. The additional acoustic adjustment member 40 is a sound absorbing cushion 4 configured to absorb sound (hereinafter referred to as “additional sound absorbing cushion” as required). This, however, is not a limitation of the additional acoustic adjustment member. For example, the additional acoustic adjustment member can be: an acoustic diffuser; a sound absorber other than a sound absorbing cushion; an acoustic reflector, such as an acoustic reflecting plate or the like; or the like. It is also possible to place no additional acoustic adjustment member in a diffusion segment. Thus, the acoustic arrangement shelf can also have a diffusion segment that contains only the acoustic adjustment member.

As shown in FIGS. 1, 2, and 5 to 9, the acoustic arrangement shelf includes at least one of the diffusion segment 11 and the sound absorption segment 12. The acoustic arrangement shelf can include both of the diffusion segment 11 and the sound absorption segment 12.

The acoustic arrangement shelf can also include only the diffusion segment 11. The acoustic arrangement shelf can include only the sound absorption segment 12. The acoustic arrangement shelf can also include a segment in which no member is placed (not shown), in addition to at least one of the diffusion segment and the sound absorption segment.

### “Specific Configuration of Shelf Frame”

With reference to FIGS. 1 to 9, the shelf frame 10 may have a specific configuration as described below. As shown in FIGS. 3 and 4, each of the segments 11 and/or 12 of the shelf frame 10 extends in the depth direction. The segments 11 and/or 12 have respective front openings 11a and 12a located at the front of the shelf frame 10. The segments 11 and/or 12 have respective back openings 11b and 12b located at the back of the shelf frame 10 and facing the front openings 11a and 12a in the depth direction. The front openings 11a and 12a of the segments 11 and/or 12 are open to a space outside of the acoustic arrangement shelf or the shelf frame 10. In particular, the front openings 11a and 12a are open to a space outside of the acoustic arrangement shelf or the shelf frame 10, for which space acoustic adjustment is to be provided. Alternatively, at least one of the segments may be closed at the back of the shelf frame. In this case, for example, a back plate can be placed on the back surface of the shelf frame.

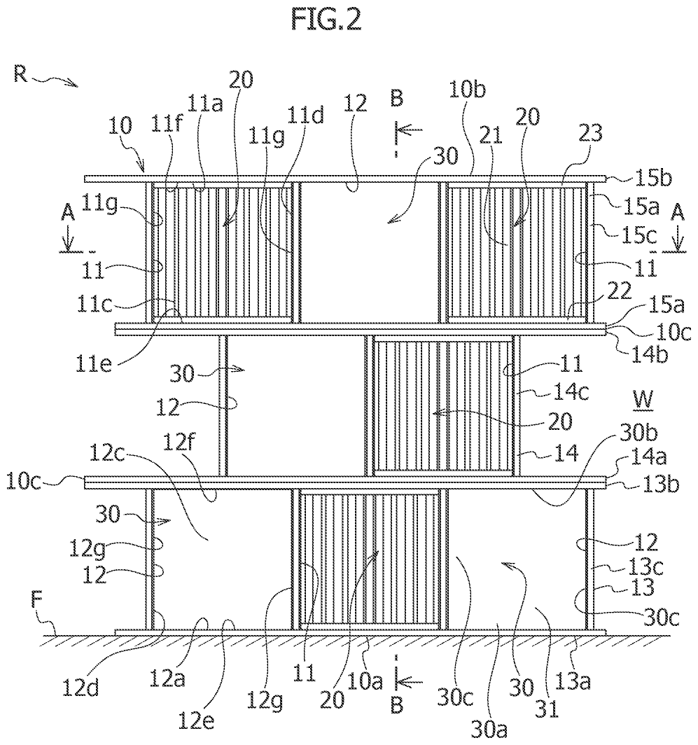

With reference to FIGS. 2 to 4, the segments 11 and 12 include respective storage spaces 11c and 12c extending in the depth direction between the front and back of the shelf frame 10. In other words, the storage space 11c extends in the depth direction between the front opening 11a and the back opening 11b, and the storage space 12c extends in the depth direction between the front opening 12a and the back opening 12b. The segments 11 and 12 have respective perimeter surfaces 11d and 12d that extend in the depth direction, surrounding the respective storage spaces 11c and 12c. The perimeter surfaces 11d and 12d include respective bottom surfaces 11e and 12e toward the bottom portion 10a of the shelf frame 10. The perimeter surfaces 11d and 12d also include respective top surfaces 11f and 12f toward the top portion 10b of the shelf frame 10. Furthermore, the perimeter surface 11d includes two side surfaces 11g, and the perimeter surface 12d includes two side surfaces 12g. The side surfaces 11g and 12g are located toward both side portions 10c of the shelf frame 10 situated in the width direction.

Cross sections of the segments 11 and 12 orthogonal to the depth direction can be substantially equal to one another in area. Shapes of the segments 11 and 12 as viewed from the front can be substantially similar to one another. These, however, are not limitations of the present invention. For example, a cross section of at least one of the segments can be different from that of another segment in area. A shape of at least one of the segments as viewed from the front can also be different from that of another segment.

A minimum width of each of the segments 11 and 12 can be equal to or greater than a maximum depth or an average depth of the corresponding one of the segments 11 and 12. A minimum width of each of the segments 11 and 12 is smaller than a maximum width of the shelf frame 10. A minimum height of each of the segments 11 and 12 can be equal to or greater than a maximum depth or an average depth of the corresponding one of the segments 11 and 12. A minimum height of each of the segments 11 and 12 is smaller than a maximum height of the shelf frame 10. However, a minimum width of at least one of the segments can also be greater than a maximum depth or an average depth of the at least one of the segments. A minimum height of at least one of the segments can also be greater than a maximum depth or an average depth of the at least one of the segments.

In FIGS. 1 to 9, each of the segments 11 and/or 12 can have a substantially rectangular shape as viewed from the front. Alternatively, each of the segments 11 and/or 12 can have a substantially square shape as viewed from the front. Each of the segments 11 and/or 12 can extend between the front and back of the shelf frame 10 so as to have a substantially rectangular cross section. Alternatively, each of the segments 11 and/or 12 can extend between the front and back of the shelf frame 10 so as to have a substantially square cross section. The shape of each segment, however, is not limited to a substantially rectangular shape or a substantially square shape. For example, at least one of the segments can have a shape as viewed from the front that is a substantially polygonal shape, a substantially circular shape, a substantially semicircular shape, a substantially crescent shape, or other geometrical shapes.

As shown in FIGS. 1, 2, and 5 to 9, the shelf frame 10 can include units 13, 14, and 15. Each of the units 13, 14, and 15 includes one segment 11 or 12, or segments 11 and/or 12 aligned in the width direction. The units 13 to 15 can be aligned in the height direction. Alternatively, the shelf frame can include only one unit, and the one unit can include one segment or a plurality of segments aligned in the width direction.

At least one of the units 13 to 15 can include at least one diffusion segment 11. At least one of the units 13 to 15 can include at least one sound absorption segment 12. At least one of the units 13 to 15 can include at least one diffusion segment 11 and at least one sound absorption segment 12.

One of the units 13 to 15 and another one of the units 13 to 15 can be placed adjacent to one another in the height direction, and a segment 11 or 12 included in the one of the units 13 to 15, can have a width-direction center shifted in the width direction from that of a segment 11 or 12 included in the other one of the units 13 to 15. Alternatively, one of the units and another one of the units can be placed adjacent to one another in the height direction, and a segment included in the one of the units, can have a width-direction center substantially coincident with that of a segment included in the other one of the units in the width direction.

FIGS. 1, 2, and 5 to 9 show examples of the shelf frame 10. In each example, the shelf frame 10 includes: the first unit 13 having three segments 11 and/or 12 aligned in the width direction; the second unit 14 having two segments 11 and/or 12 aligned in the width direction, the second unit 14 being adjacent to a portion of the first unit 13 located toward the top portion 10b of the shelf frame 10 in the height direction; and the third unit 15 having three segments 11 and/or 12 aligned in the width direction, the third unit 15 being adjacent to a portion of the second unit 14 located toward the top portion 10b of the shelf frame 10 in the height direction. The first unit 13 includes two diffusion segments 11 and one sound absorption segment 12. The second unit 14 includes one diffusion segment 11 and one sound absorption segment 12. The third unit 15 includes one diffusion segment 11 and two sound absorption segments 12. However, the configuration of the shelf frame is not limited to those provided as examples in the FIGS. 1, 2, and 5 to 9.

The units 13, 14, and 15 include respective bottom plates 13a, 14a, and 15a located toward the bottom portion 10a of the shelf frame 10. The units 13, 14, and 15 include respective top plates 13b, 14b, and 15b being located toward the top portion 10b of the shelf frame 10 and being spaced apart from the respective bottom plates 13a, 14a, and 15a in the height direction. In the units 13 to 15, respective spacings between the bottom plates 13a to 15a and the top plates 13b to 15b are set so that the segments 11 and/or 12 can be formed therebetween. The segments 11 and/or 12 in the units 13 to 15 are defined in the height direction by the respective bottom plates 13a to 15a and the respective top plates 13b to 15b.

The unit 13 includes a plurality of side plates 13c extending between the bottom plate 13a and the top plate 13b and being spaced apart from one another in the width direction. The unit 14 includes a plurality of side plates 14c extending between the bottom plate 14a and the top plate 14b and being spaced apart from one another in the width direction. The unit 15 includes a plurality of side plates 15c extending between the bottom plate 15a and the top plate 15b and being spaced apart from one another in the width direction. The segments 11 and/or 12 in the units 13 to 15 are defined in the width direction by the pluralities of side plates 13c to 15c, respectively. One of the units 13 to 15 and another one of the units 13 to 15 are adjacent to one another in the height direction, and one of the bottom plates 13a to 15a associated with the one of the units 13 to 15, is in contact with one of the top plates 13b to 15b associated with the other one of the units 13 to 15.

As shown in FIGS. 1 and 2, one ends of the bottom plates 13a to 15a and top plates 13b to 15b of the units 13 to 15 in the width direction may be substantially coincident with one another in the width direction. In this case, as shown in FIG. 9, the shelf frame 10 in the sideways position can be placed with one of the ends in the width direction in contact with the floor surface F of the acoustic adjustment room R. That is, the shelf frame 10 can be placed on the floor surface F of the acoustic adjustment room R in the sideways position. Furthermore, the shelf frame 10 can be placed along the side wall surface W in the sideways position.

The bottom plates 13a to 15a and top plates 13b to 15b of the units 13 to 15 may be reversible in the width direction. In this case, the shelf frame 10 can be changed between states; that is, between a state in which, as shown in FIGS. 1 and 2, one of the ends of the bottom plates 13a to 15a and top plates 13b to 15b of the units 13 to 15 in the width direction are substantially coincident with one another in the width direction and a state in which, as shown in FIGS. 5 to 8, some of one of the ends of the bottom plates 13a to 15a and top plates 13b to 15b of the units 13 to 15 in the width direction are shifted in the width direction with respect to others of the one ends.

The perimeter surface 11d or 12d of at least one of the segments 11 and 12 included in the shelf frame 10, can include at least one through hole (not shown) in communication with the outside of the at least one of the segments 11 and 12. Acoustic properties can also be adjusted by adjusting the at least one through hole of the acoustic arrangement shelf in number, size, location, shape, and/or the like as appropriate.

### “Specific Configuration of Acoustic Adjustment Member”

With reference to FIGS. 1 to 9, the acoustic adjustment members 20 and 30 may have specific configurations as described below. As shown in FIGS. 1 to 9, the acoustic adjustment member 20 is placed to cover a portion or all of the storage space 11c in the depth direction in the segment 11 in which the acoustic adjustment member 20 is placed. The acoustic adjustment member 30 is placed to cover a portion or all of the storage space 12c in the depth direction in the segment 12 in which the acoustic adjustment member 30 is placed.

As shown in FIGS. 1 to 7 and 9, when the acoustic adjustment member 20 is the acoustic diffuser 20, each of the columnar portions 21 of the acoustic diffuser 20 has an elongated shape. The columnar portions 21 may extend in substantially the same direction. As used herein, in the acoustic diffuser 20, a direction substantially identical with the depth direction of the shelf frame 10 is defined as a thickness direction, a direction in which the columnar portions 21 extend is defined as a vertical direction, and a direction substantially orthogonal to the thickness direction and the vertical direction is defined as a lateral direction. A state in which the acoustic diffuser 20 is placed as shown in FIGS. 1 to 4, is specifically defined as a vertically placed state. When the acoustic diffuser 20 is in the vertically placed state, the thickness direction, the vertical direction, and the lateral direction of the acoustic diffuser 20 substantially agree with the depth direction, the height direction, and the width direction of the shelf frame 10, respectively.

In FIGS. 1 to 4 and 9, all the acoustic diffusers 20 are in the vertically placed state. In FIGS. 5 to 8, some of the acoustic diffusers 20 are in the vertically placed state, and the remainder of the acoustic diffusers 20 are in a laterally placed state as described below. That is, a state in which the remainder of the acoustic diffusers 20 are placed as shown in FIGS. 5 to 8 is defined as the laterally placed state. When the acoustic diffuser 20 is in the laterally placed state, the thickness direction, the vertical direction, and the lateral direction of the acoustic diffuser 20 substantially agree with the depth direction, the width direction, and the height direction of the shelf frame 10, respectively.

The acoustic diffuser 20 includes two support portions 22 and 23 located at both end portions of the acoustic diffuser 20 in the vertical direction, namely, a first support portion 22 and a second support portion 23. Both ends of each of the columnar portions 21 in the extending direction are coupled to the two support portions 22. The columnar portions 21 are placed spaced apart from one another. One of the ends of the two support portions 22 and 23 in the lateral direction are substantially coincident with one another in the lateral direction. The other of the ends of the two support portions 22 and 23 in the lateral direction can also be substantially coincident with one another in the lateral direction.

When the acoustic diffuser 20 is in the vertically placed state, the first support portion 22 is in contact with the bottom surface 11e of the diffusion segment 11. The second support portion 23 may further be placed along the top surface 11f of the diffusion segment 11. When the acoustic diffuser 20 is in the laterally placed state, one of the ends of the first and second support portions 22 and 23 in the lateral direction are in contact with the bottom surface 11e of the diffusion segment 11. The first and second support portions 22 and 23 may further be placed along both side surfaces 11g of the diffusion segment 11.

The acoustic diffuser 20 can be a columnar diffuser of Acoustic Grove System (AGS) (“Acoustic Grove” is a registered trademark). The acoustic diffuser can also include a back portion located on the back side of the columnar portions in the thickness direction.

As shown in FIGS. 3 and 4, when the acoustic adjustment member 30 is the sound absorbing cushion 30, the sound absorbing cushion 30 includes a covering portion 31 situated at an outer surface of the sound absorbing cushion 30 to define an inner space of the sound absorbing cushion 30. The inner space of the sound absorbing cushion 30 may be a closed space surrounded by the covering portion 31.

The sound absorbing cushion 30 also includes a sound absorbing portion 32 in the inner space. This, however, is not a limitation of the sound absorbing cushion. For example, the sound absorbing cushion may include only a sound absorbing portion without a covering portion.

As used herein, in the sound absorbing cushion 30, directions that are substantially identical with the depth direction, the height direction, and the width direction of the shelf frame 10 are defined as a depth direction, a height direction, and a width direction, respectively. A bottom portion 30a of the sound absorbing cushion 30 in the height direction is in contact with the bottom surface 12e of the sound absorption segment 12. The sound absorbing cushion 30 can be supported either in a state in which the sound absorbing cushion 30 is sandwiched between the bottom surface 12e and the top surface 12f of the sound absorption segment 12 in the height direction or in a state in which the sound absorbing cushion 30 is sandwiched between both side surfaces 12g of the sound absorption segment 12 in the width direction. A top portion 30b of the sound absorbing cushion in the height direction may be placed along the top surface of the sound absorption segment 12. Both side portions 30c of the sound absorbing cushion in the width direction may be placed along both side surfaces 12g of the sound absorption segment 12.

The covering portion 31 of the sound absorbing cushion 30 may have flexibility. The covering portion 31 may be acoustically transmissive. The covering portion 31 may have air permeability. The covering portion 31 may specifically be made of natural leather, synthetic leather, woven fabric, and/or nonwoven fabric. This, however, is not a limitation of the covering portion.

The sound absorbing portion 32 of the sound absorbing cushion 30 is made using a material having sound absorbing capability. For example, the sound absorbing portion 32 can be made of glass wool. This, however, is not a limitation of the material of the sound absorbing portion. The sound absorbing portion can also be made of rock wool. The sound absorbing portion can also be made from plastic fiber, such as polyester fiber, polyethylene terephthalate (PET) fiber, polymethyl methacrylate (PMMA) fiber, polyimide (PI) fiber, and/or the like. The sound absorbing portion can also be made of a material containing glass wool, rock wool, plastic fibers described above, and/or the like. The sound absorbing portion can also be made of a sponge material made from resin and/or the like. Furthermore, the sound absorbing cushion can include an additional member between the covering portion and the sound absorbing portion. The additional member is formed to surround a portion or all of the sound absorbing portion. For example, the additional member can be a corrugated cardboard plate, a rubber plate, aluminum foil, a film made from materials such as polyester, and/or the like.

### “Specific Configuration of Additional Adjustment Member”

With reference to FIGS. 3 and 4, the additional acoustic adjustment member 40 may have a specific configuration as described below. The additional acoustic adjustment member 40 is placed to cover a portion of the storage space 11c in the depth direction in the segment 11 in which the acoustic adjustment member 20 is placed. When the additional acoustic adjustment member 40 is the additional sound absorbing cushion 40, the additional sound absorbing cushion 40 includes a covering portion 41 situated at an outer surface of the additional sound absorbing cushion 40 to define an inner space of the additional sound absorbing cushion 40. The inner space of the additional sound absorbing cushion 40 may be a closed space surrounded by the covering portion 41.

The additional sound absorbing cushion 40 also includes a sound absorbing portion 42 in the inner space. This, however, is not a limitation of the additional sound absorbing cushion. For example, the additional sound absorbing cushion can include only a sound absorbing portion without a covering portion.

As used herein, in the additional sound absorbing cushion 40, directions that are substantially identical with the thickness direction, the vertical direction, and the lateral direction of the acoustic diffuser 20, are defined as a thickness direction, a vertical direction, and a lateral direction, respectively. The additional sound absorbing cushion 40 may be in contact with the acoustic diffuser 20 in the thickness direction. The additional sound absorbing cushion 40 may be removably attached to the acoustic diffuser 20. This, however, is not a limitation of the additional sound absorbing cushion. For example, the additional sound absorbing cushion can be joined to the acoustic diffuser. Alternatively, the additional sound absorbing cushion can be supported by the perimeter surface of the sound absorption segment.

When the acoustic diffuser 20 is in the vertically placed state, the thickness direction, the vertical direction, and the lateral direction of the additional sound absorbing cushion 40 substantially agree with the depth direction, the height direction, and the width direction of the shelf frame 10, respectively, in correspondence to the acoustic diffuser 20. When the acoustic diffuser 20 is in the laterally placed state, the thickness direction, the vertical direction, and the lateral direction of the additional sound absorbing cushion 40 substantially agree with the depth direction, the width direction, and the height direction of the shelf frame 10, respectively, in correspondence to the acoustic diffuser 20.

The covering portion 41 of the additional sound absorbing cushion 40 may have flexibility. The covering portion 41 may be acoustically transmissive. The covering portion 41 may have air permeability. The covering portion 41 may specifically be made of natural leather, synthetic leather, woven fabric, and/or nonwoven fabric. The covering portion 41 of the additional sound absorbing cushion 40 may be made of a material that is the same as or different from that of the covering portion 31 of the sound absorbing cushion 30. This, however, is not a limitation of the covering portion.

The sound absorbing portion 42 of the additional sound absorbing cushion 40 is made using a material having sound absorbing capability. The sound absorbing portion 42 of the additional sound absorbing cushion 40 may be made of a material that is the same as or different from that of the sound absorbing portion 32 of the sound absorbing cushion 30. For example, the sound absorbing portion 42 can be made of glass wool. This, however, is not a limitation of the material of the sound absorbing portion. The sound absorbing portion can also be made of rock wool. The sound absorbing portion can also be made from polyester fiber, PET fiber, acrylic fiber, polyimide fiber, and/or other plastic fibers. The sound absorbing portion can also be made of a material containing glass wool, rock wool, plastic fibers described above, and/or the like. The sound absorbing portion can also be made of a material containing glass wool, rock wool, plastic fibers described above, and/or the like. The sound absorbing portion can also be made of a sponge material made from resin and/or the like. Furthermore, the additional sound absorbing cushion can include an additional member between the covering portion and the sound absorbing portion. The additional member is formed to surround a portion or all of the sound absorbing portion. For example, the additional member can be a corrugated cardboard plate, a rubber plate, aluminum foil, a film made from materials such as polyester, and/or the like.

### “Variations of Acoustic Arrangement Shelf”

With reference to FIGS. 2 and 5 to 9, the acoustic arrangement shelf can be placed in various Aspects as described below. That is, as shown in FIG. 2, the shelf frame 10 in the acoustic arrangement shelf according to a First Aspect of the present Embodiment can include a plurality of diffusion segments 11 and a plurality of sound absorption segments 12. In all the diffusion segments 11, the acoustic diffusers 20 can be placed in the vertically placed state. One ends of the bottom plates 13a to 15a and top plates 13b to 15b of the units 13 to 15 in the width direction can be substantially coincident with one another in the width direction. The shelf frame 10 can be placed in the basic position with the bottom portion 10a in contact with the floor surface F of the acoustic adjustment room R.

As shown in FIG. 5, the shelf frame 10 in the acoustic arrangement shelf according to a Second Aspect of the present Embodiment can include a plurality of diffusion segments 11 and a plurality of sound absorption segments 12. In all the diffusion segments 11, the acoustic diffusers 20 can be placed in the vertically placed state. Some of one of the ends of the bottom plates 13a to 15a and top plates 13b to 15b of the units 13 to 15 in the width direction can be shifted in the width direction with respect to others of the one of the ends. The shelf frame 10 can be placed in the basic position with the bottom portion 10a in contact with the floor surface F of the acoustic adjustment room R.

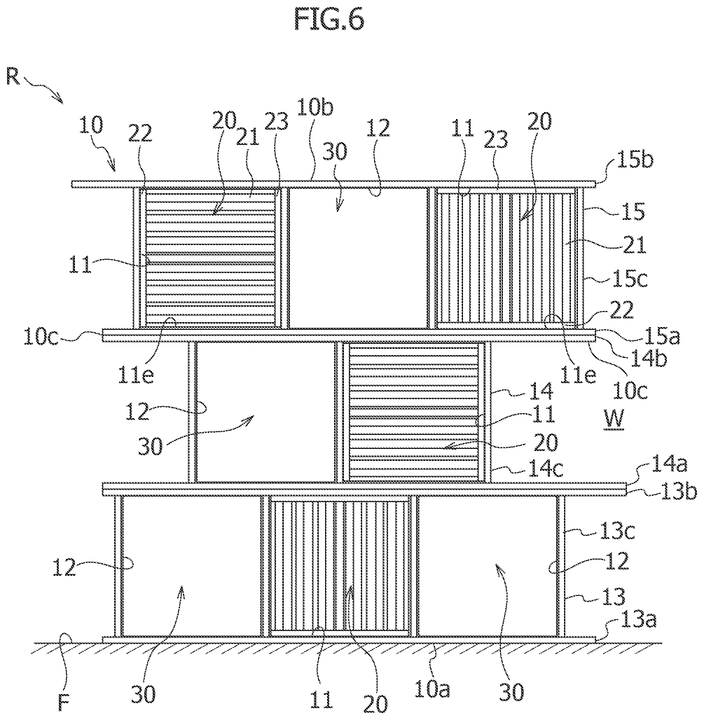

As shown in FIG. 6, the shelf frame 10 in the acoustic arrangement shelf according to a Third Aspect of the present Embodiment can include a plurality of diffusion segments 11 and a plurality of sound absorption segments 12. The acoustic diffusers 20 in some of the diffusion segments 11 can be in the vertically placed state, and the acoustic diffusers 20 in the remainder of the diffusion segments 11 can be in the laterally placed state. Some of one of the ends of the bottom plates 13a to 15a and top plates 13b to 15b of the units 13 to 15 in the width direction can be shifted in the width direction with respect to others of the one of the ends. The shelf frame 10 can be placed in the basic position with the bottom portion 10a in contact with the floor surface F of the acoustic adjustment room R.

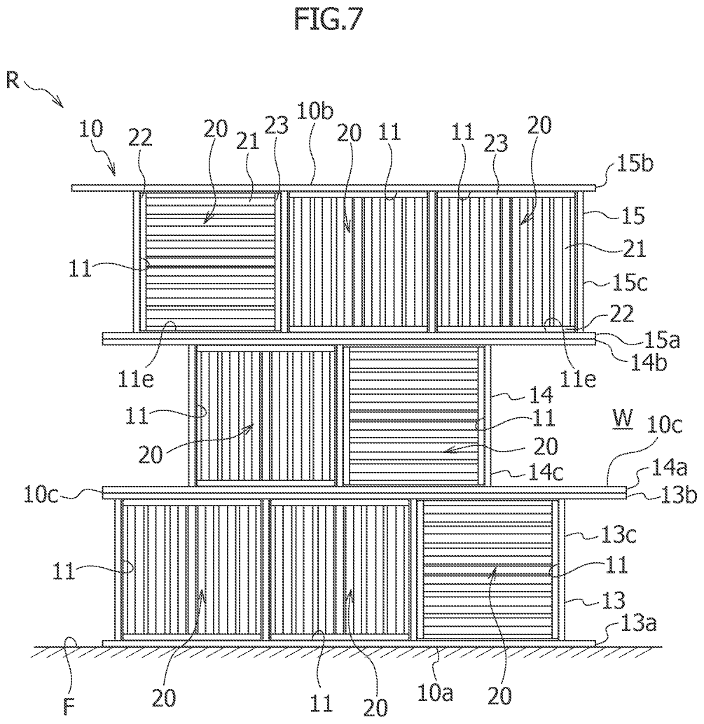

As shown in FIG. 7, the shelf frame 10 in the acoustic arrangement shelf according to a Fourth Aspect of the present Embodiment can include a plurality of diffusion segments 11 only. The acoustic diffusers 20 in some of the diffusion segments 11 can be in the vertically placed state, and the acoustic diffusers 20 in the remainder of the diffusion segments 11 can be in the laterally placed state. Some of one of the ends of the bottom plates 13a to 15a and top plates 13b to 15b of the units 13 to 15 in the width direction can be shifted in the width direction with respect to others of the one of the ends. The shelf frame 10 can be placed in the basic position with the bottom portion 10a in contact with the floor surface F of the acoustic adjustment room R.

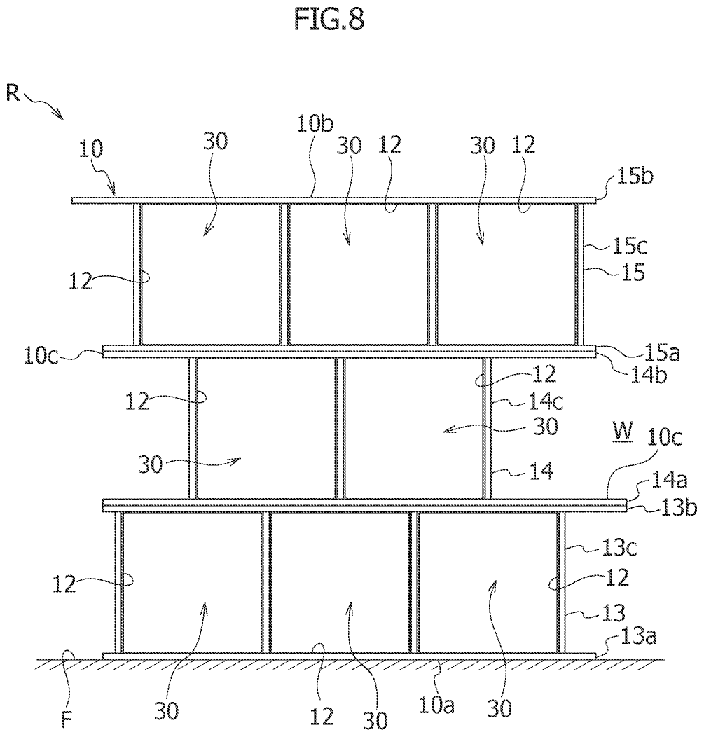

As shown in FIG. 8, the shelf frame 10 in the acoustic arrangement shelf according to a Fifth Aspect of the present Embodiment can include a plurality of sound absorption segments 12 only. Some of one of the ends of the bottom plates 13a to 15a and top plates 13b to 15b of the units 13 to 15 in the width direction can be shifted in the width direction with respect to others of the one of the ends. The shelf frame 10 can be placed in the basic position with the bottom portion 10a in contact with the floor surface F of the acoustic adjustment room R.

As shown in FIG. 9, the shelf frame 10 in the acoustic arrangement shelf according to a Sixth Aspect of the present Embodiment can include a plurality of diffusion segments 11 and a plurality of sound absorption segments 12. In all the diffusion segments 11, the acoustic diffusers 20 can be placed in the vertically placed state. One of the ends of the bottom plates 13a to 15a and top plates 13b to 15b of the units 13 to 15 in the width direction can substantially be coincident with one another in the width direction. The shelf frame 10 can be placed in the sideways position with a side portion 10c of the shelf frame 10 in contact with the floor surface F of the acoustic adjustment room R.

The First to Sixth Aspects of the acoustic arrangement shelf are provided merely as examples. In addition to the First to Sixth Aspects, the acoustic arrangement shelf can be placed in any Aspect including the configurations of the present Embodiment.

As described above, the acoustic arrangement shelf according to the present Embodiment includes: the shelf frame 10 having the segments 11 and/or 12; and the acoustic adjustment member 20 and/or 30 configured to be removably placed in at least one of the segments 11 and/or 12 and change a property of input sound. Accordingly, acoustic properties can be adjusted with ease by changing the types of acoustic adjustment members 20 and/or 30 to be placed in the segments 11 and/or 12 of the shelf frame 10. Additionally, since the acoustic adjustment members 20 and/or 30, which are sterile, are stored in the shelf frame 10, the acoustic arrangement shelf has enhanced aesthetic appeal. As a result, the acoustic adjustment room R or the acoustic adjustment space, in which the acoustic arrangement shelf is placed, can have enhanced aesthetic appeal.

In the acoustic arrangement shelf according to the present Embodiment, the acoustic adjustment member 20 can be the acoustic diffuser 20 including the columnar portions 21 each configured to reflect input sound. The acoustic diffuser 20 significantly affects acoustic properties, especially an acoustic diffusing property, an acoustic reflecting property, and the like. Thus, acoustic properties can be adjusted with ease by changing the type of acoustic diffuser 20 to be placed in the diffusion segment 11 of the shelf frame 10. Although the acoustic diffuser 20 is, in particular, sterile in appearance, the aesthetic appeal of the acoustic arrangement shelf will not be reduced because the acoustic diffuser 20 is stored in the shelf frame 10. As a result, the acoustic adjustment room R or the acoustic adjustment space, in which the acoustic arrangement shelf is placed, can have enhanced aesthetic appeal.

The acoustic arrangement shelf according to the present Embodiment includes the additional acoustic adjustment member 40 configured to be removably placed in the diffusion segment 11 on the back side of the shelf frame 10 with respect to the acoustic adjustment member 20 and change a property of input sound. The additional acoustic adjustment member 40 can be the additional sound absorbing cushion 40, which is configured to absorb sound. The acoustic diffuser 20 and the additional acoustic adjustment member 40 in combination significantly affect acoustic properties, in particular, an acoustic reflecting property and a sound absorbing property. Accordingly, acoustic properties can be adjusted with ease by changing at least one of the type of acoustic diffuser 20 and the type of additional acoustic adjustment member 40 to be placed in the diffusion segment 11 of the shelf frame 10. As a result, the acoustic adjustment room R or the acoustic adjustment space, in which the acoustic arrangement shelf is placed, can have enhanced aesthetic appeal.

In the acoustic arrangement shelf according to the present Embodiment, the acoustic adjustment member 30 can be the sound absorbing cushion 30 configured to absorb sound. The sound absorbing cushion 30 significantly affects acoustic properties, especially a sound absorbing property. Accordingly, acoustic properties can be adjusted with ease by changing the type of sound absorbing cushion 30 to be placed in the sound absorption segment 12 of the shelf frame 10. Additionally, since the sound absorbing cushion 30 is stored in the shelf frame 10, the acoustic arrangement shelf can have enhanced aesthetic appeal. As a result, the acoustic adjustment room R or the acoustic adjustment space, in which the acoustic arrangement shelf is placed, can hold enhanced aesthetic appeal.

While an Embodiment of the present invention has been described above, the present invention is not limited to the aforementioned Embodiment and can be modified or changed based on the technical concept of the present invention.

### EXAMPLES

Relationships between acoustic frequency and sound absorption coefficient of acoustic arrangement shelves of Examples 1 to 5 were measured in accordance with JIS A 1409, titled “Method for measurement of sound absorption coefficients in a reverberation room,” and compared to one another. For the measurement, each acoustic arrangement shelf was placed while the back surface of the shelf frame thereof is in contact with the wall surface of a reverberation room. The following describes in detail the acoustic arrangement shelves of Examples 1 to 5, the relationships between acoustic frequency and sound absorption coefficient of the acoustic arrangement shelves, and a comparison result of relationships between acoustic frequency and sound absorption coefficient.

### Example 1

The acoustic arrangement shelf of Example 1 was prepared similar to the acoustic arrangement shelf according to the First Aspect of the present Embodiment. In the acoustic arrangement shelf of Example 1, the shelf frame has included eight segments, four of which were diffusion segments and the remaining four were sound absorption segments. In the first unit, which was located toward the bottom portion of the shelf frame, a sound absorption segment, a diffusion segment, and a sound absorption segment were placed from left to right as viewed from the front. In the second unit, which was located toward the top portion of the shelf frame with respect to the first unit, a sound absorption segment and a diffusion segment were placed from left to right as viewed from the front. In the third unit, which was located toward the top portion of the shelf frame with respect to the second unit, a diffusion segment, a sound absorption segment, and a diffusion segment were placed from left to right as viewed from the front. In each diffusion segment, the acoustic diffuser in the vertically placed state and the additional sound absorbing cushion were placed. In each sound absorption segment, the sound absorbing cushion was placed.

### Example 2

The acoustic arrangement shelf of Example 2 was prepared similar to the acoustic arrangement shelf according to the Fourth Aspect of the present Embodiment, except that all the acoustic diffusers were placed in the vertically placed state. In the acoustic arrangement shelf of Example 2, the shelf frame has included eight segments, all of which were diffusion segments. In each diffusion segment, the acoustic diffuser in the vertically placed state and the additional sound absorbing cushion were placed.

### Example 3

The acoustic arrangement shelf of Example 3 was prepared similar to the acoustic arrangement shelf according to the Fifth Aspect of the present Embodiment. In the acoustic arrangement shelf of Example 3, the shelf frame has included eight segments, all of which were sound absorption segments. In each sound absorption segment, the sound absorbing cushion was placed.

### Example 4

The acoustic arrangement shelf of Example 4 was prepared similar to the acoustic arrangement shelf of Example 1, except that only the acoustic diffuser was placed in each diffusion segment.

### Example 5

The acoustic arrangement shelf of Example 5 was prepared similar to the acoustic arrangement shelf of Example 2, except that only the acoustic diffuser was placed in each diffusion segment.

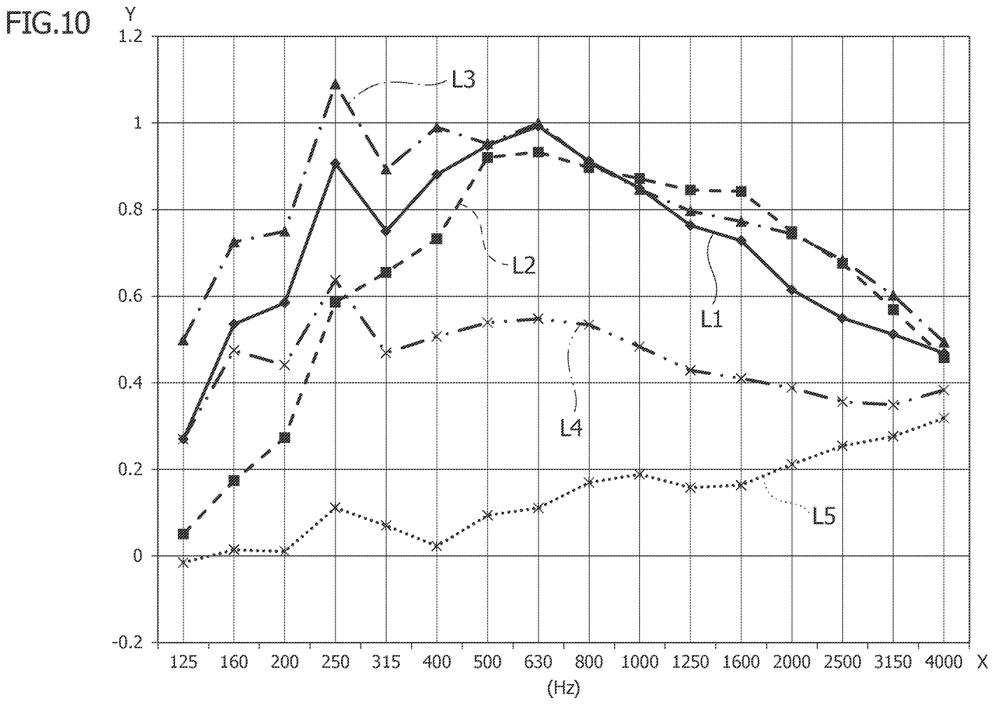

Relationships between acoustic frequency and sound absorption coefficient of the acoustic arrangement shelves of Examples 1 to 5 were found as shown in FIG. 10. In FIG. 10, the vertical axis Y represents sound absorption coefficient, and the vertical axis X represents frequency (Hz). A solid line L1 represents the result of Example 1; a broken line L2 represents the result of Example 2; a chain line L3 represents the result of Example 3; two-dot chain line L4 represents the result of Example 4; and a dotted line L5 represents the result of Example 5. Note that when no element such as an acoustic arrangement shelf is placed in the reverberation room, the sound absorption coefficient is zero at each frequency.

The comparison of relationships between acoustic frequency and sound absorption coefficient of the acoustic arrangement shelves of Examples 1 to 5 demonstrated that the acoustic arrangement shelves were capable of changing acoustic properties depending on the number of diffusion segments, the number of sound absorption segments, and the presence or absence of the additional sound absorbing cushion in the diffusion segment. Accordingly, it has been verified that the acoustic arrangement shelf can facilitate adjustment of acoustic properties.

### REFERENCE SIGNS LIST

10 . . . Shelf frame, 11 . . . Diffusion segment (segment), 12 . . . Sound absorption segment (Segment)

20 . . . Acoustic diffuser (Acoustic adjustment member), 21 . . . Columnar portion

30 . . . Sound absorbing cushion (Acoustic adjustment member)

40 . . . Additional sound absorbing cushion (Sound absorbing cushion, Additional acoustic adjustment member)

1. An acoustic arrangement shelf comprising:
a shelf frame including a plurality of segments; and
an acoustic adjustment member configured to be removably placed in at least one of the segments and configured to change a property of an input sound.

2. The acoustic arrangement shelf according to claim 1, wherein the acoustic adjustment member is an acoustic diffuser including a plurality of columnar portions each configured to reflect the input sound.

3. The acoustic arrangement shelf according to claim 2, further comprising an additional acoustic adjustment member configured to be removably placed in the at least one of the segments on a back side of the shelf frame with respect to the acoustic adjustment member and configured to change a property of the input sound, wherein the additional acoustic adjustment member is a sound absorbing cushion configured to absorb sound.

4. The acoustic arrangement shelf according to claim 1, wherein the acoustic adjustment member is a sound absorbing cushion configured to absorb sound.
